(19) United States
(12) Patent Application Publication
(10) Pub. No.: US 2014/0316075 A1
(43) Pub. Date: Oct. 23, 2014

(54) Linear Silicone Block Copolymer and Method of Making the Same

(71) Applicants: Xiaohua Wang, Shanghai (CN); Wanglin Yu, Pearland, TX (US); Liqiang Fan, Shanghai (CN); Shaoguang Feng, Midland, MI (US)

(72) Inventors: Xiaohua Wang, Shanghai (CN); Wanglin Yu, Pearland, TX (US); Liqiang Fan, Shanghai (CN); Shaoguang Feng, Midland, MI (US)

(21) Appl. No.: 14/356,760

(22) PCT Filed: Nov. 17, 2011
(86) PCT No.: PCT/CN2011/082331

§ 371 Date: May 7, 2014

(51) Int. Cl. C08G 77/46; C08G 18/62

(52) U.S. Cl. CPC C08G 77/46; C08G 18/62
USPC 525/452; 528/75

(57) ABSTRACT

The present disclosure provides a composition comprising a linear silicone block copolymer of Formula (IV) wherein R is a hydrogen or a C₃-C₈ alkyl group, A is a three carbon or four carbon oxylalkylene unit, “m” is an integer from 6 to 50, “n” is an integer from 0 to 30, and the average number for “q” is from 2 to 50, and method of making the same.

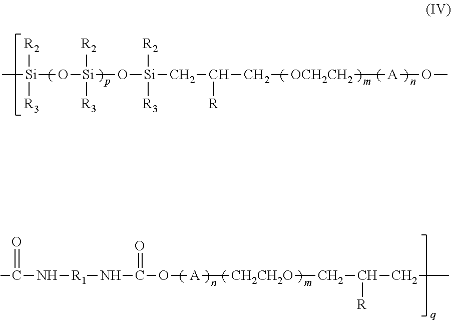

### FIELD OF THE INVENTION

This invention relates to a composition and method of making a linear silicone block copolymer.

### INTRODUCTION

Polysiloxane with polyoxyethylene, polyoxypropylene, or polyoxyethylene polyoxypropylene groups connected in its molecular side chains or blocked in the backbone can be used for fabric softener to yield a more hydroscopic and antistatic fabric. Polyether block polydimethylsiloxane can also make the fabric more favorable in softness, smoothness and grip performance

Present copolymers containing nitrogen, polyether, and dihydride-terminated polymethylsiloxane involve a multistep reaction and result in the nitrogen groups being amine, quarternary ammonium or amide groups.

There exists a need for an efficient synthesis of a linear silicone block copolymer containing carbamate functional groups and having a polysiloxane block copolymer as a terminating group.

### SUMMARY

Linear silicone block copolymers containing nitrogen-containing functional groups, polyether groups, as well as silicone groups are useful in silicone softener applications for textiles or as ingredients in formulations for personal care. These linear silicone block copolymers are particularly advantageous in textile applications by having an adjustable hydrophilicity and improved chemical compatibility. When used in softening compositions, little or no emulsifier is needed and a lower concentration may be used on fabrics than a solution that does not contain the linear silicone block copolymer.

In one embodiment, the disclosure provides composition comprising a diallyl carbamate polyether of Formula I

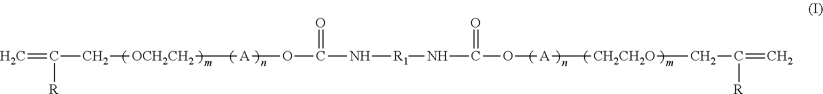

wherein R is a hydrogen, or a C₃-C₈ alkyl group, A is a three carbon or four carbon oxylalkylene unit, “m” is an integer from 6 to 50, and “n” is an integer from 0 to 30.

In an embodiment, the disclosure provides a composition comprising a linear silicone block copolymer of Formula IV

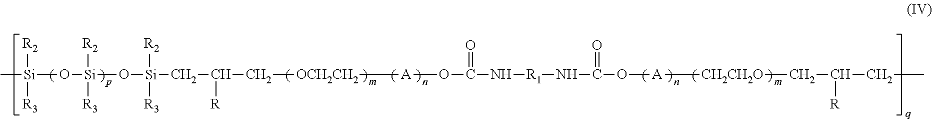

wherein R is a hydrogen, or a C₃-C₈ alkyl group, A is a three carbon or four carbon oxylalkylene unit, the average “m” is from 6 to 50, the average “n” is from 0 to 30, and the average “q” is from 2 to 50.

In an embodiment, the disclosure provides a method of synthesizing a linear silicone block copolymer comprising the steps of:
a) contacting an allyl alcohol polyalkoxylate glycol of Formula II

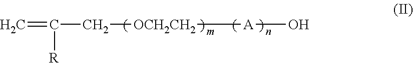

wherein R is a hydrogen, or a C₃-C₈ alkyl group, A is a three carbon or four carbon oxylalkylene unit, “m” is an integer from 6 to 50, and “n” is an integer from 0 to 30, with a diisocyanate of Formula III under reaction conditions,

OCN—R₁—NCO (III)

wherein R₁ is a divalent aliphatic, cycloaliphatic, or aromatic radical yielding a diallyl carbamate polyether of Formula I

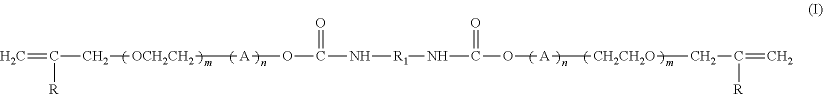

wherein R is a hydrogen, or a C₃-C₈ alkyl group, A is a three carbon or four carbon oxylalkylene unit, “m” is an integer from 6 to 50, and “n” is an integer from 0 to 30; and
b) contacting the diallyl carbamate polyether with a polysiloxane to yield a linear silicone block copolymer of Formula IV under reaction conditions

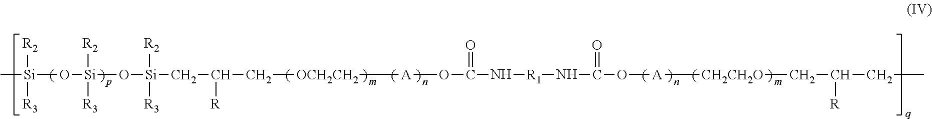

wherein R is a hydrogen, or a C₃-C₈ alkyl group, A is a three carbon or four carbon oxylalkylene unit, “m” is an integer from 6 to 50, and “n” is an integer from 0 to 30.

### DETAILED DESCRIPTION

### Definitions

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, etc., is from 100 to 1,000, then all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the molecular weights.

### Diallyl Carbamate Polyether

The diallyl carbamate polyether of the present disclosure is depicted below in Formula I.

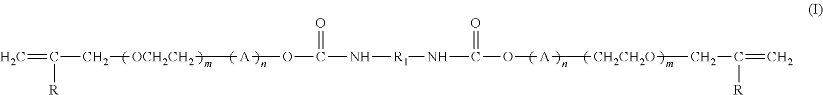

In Formula I, R is a hydrogen or a C₃-C₈ (a three carbon to eight carbon) alkyl group. A is a three carbon or four carbon alkylene oxide unit. R₁ is a divalent aliphatic, cycloaliphatic, or aromatic radical. The “m” value is an integer from 6 to 50. The “n” value is an integer from 0 to 30. Typically, “m” is greater than “n”.

In an embodiment, R is hydrogen in Formula I. In an embodiment, A is a group derived from propylene oxide, e.g., a group in the polymer backbone with a formula —CH₂CH₂CH₂—O—. In an embodiment, “m” is from 6 to 30. In an embodiment, “n” is from 0 to 15. In an embodiment, “m” is from 20 to 25 and “n” is from 5 to 10.

In an embodiment, the diallyl carbamate polyether is solid at 25° C.

In an embodiment, the diallyl carbamate polyether is formed by contacting an allyl alcohol polyalkoxylate glycol of Formula II with a diisocyanate of Formula III under first reaction conditions.

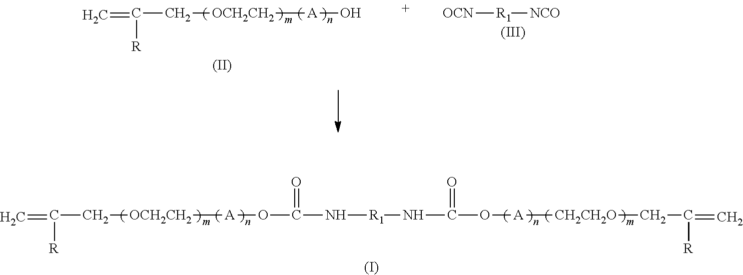

The allyl alcohol polyalkoxylate glycol of Formula II is depicted below. In an embodiment, R is a hydrogen or a C₃-C₈ (a three carbon to eight carbon) alkyl group. A is a three carbon or four carbon alkylene oxide unit. The “m” is an integer from 6 to 50. The “n” is an integer from 0 to 30.

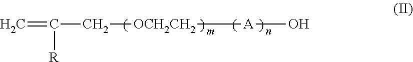

In an embodiment, the diisocyanate of Formula III is a divalent aliphatic, cycloaliphatic, or aromatic radical, for example, methylene diphenyl diisocyanate, hexamethylene diisocyanate, toluene diisocyanate, 1,5-napthalene diisocyanate or isophorone diisocyanate. R₁ may be methylene diphenyl, hexamethylene, toluene, 1,5-napthalene, or isophorone.

OCN—R₁—NCO (III)

In an embodiment, the reaction of the allyl alcohol polyalkoxylate glycol of Formula II with the diisocyante of Formula III is performed without the presence of a catalyst.

Typically, the first reaction conditions include combining from 2 to 2.5 equivalents of allyl alcohol polyalkoxylate glycol of Formula II with 1 equivalents of the diisocyanate of Formula III in an organic solvent, for example toluene, xylene or benzene. The reaction is performed at a temperature below the boiling point of the solvent and under atmospheric pressure. Typically, the allyl alcohol polyalkoxylate glycol is gradually added into the diisocyanate under toluene reflux. The conversion may be monitored by Fourier Transform Infrared spectroscopy (FTIR). After reaction completion the solvent is removed by distillation.

### Linear Silicone Block Copolymer

The disclosure also provides for a linear silicone block copolymer of Formula IV, wherein “m”, “n”, R, and R₁ are defined above, and the average “q” is from 2 to 50.

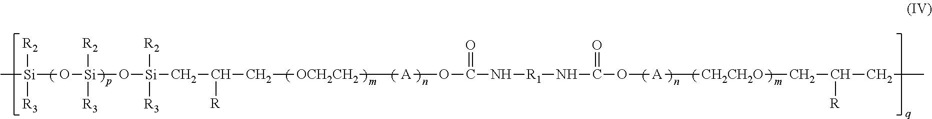

The linear silicone block copolymer of Formula IV is formed by contacting the diallyl carbamate polyether of Formula I with a polysiloxane of Formula V under reaction conditions.

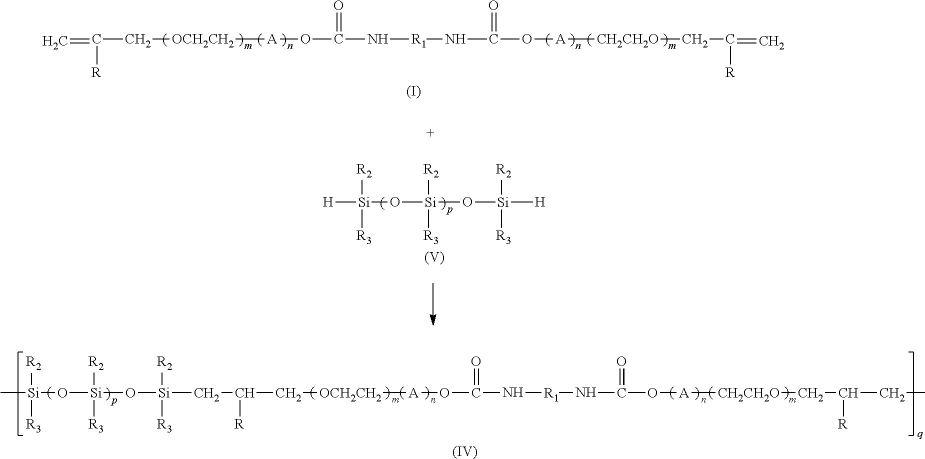

In an embodiment, the polysiloxane is of Formula V where R₂ and R₃ are alkyl groups having from 1 to 8 carbon atoms, and “p” is from 5 to 200. In an embodiment, the polysiloxane is dihydride polymethylsiloxane such that R₂ and R₃ are both methyl groups. In an embodiment, “p” is from 10 to 50.

The resulting linear silicone block copolymer of Formula IV contains at least one terminal polysiloxane block, polyether blocks and carbamate functional groups and has an average molecular weight from 5,000 g/mol to 19,000 g/mol.

The reaction to form the linear silicone block copolymer typically involves combining 1 equivalents of the diallyl carbamate polyether with from 1 to 1.1, for example 1.05, equivalents of polysiloxane in the presence of catalysts. Useful catalysts include those known in the art for hydrosilation reactions, for example platinum based catalysts. Typical solvents used in the hydrosilation reaction include toluene or ethyl acetate. The reaction is typically performed at a temperature coinciding with the reflux temperature of the solvent used.

### Applications

The linear silicone block copolymer may be used as an ingredient in softening agents for textiles, hair products, leather care products, defoaming agent, foaming agent in polyurethane foam production, and adjuvants for agriculture.

### SPECIFIC EMBODIMENTS

### Comparative Example 1 (CE 1)

35 grams (g) (0.1 mol) of APEG 350 (a polyethylene glycol available from The Dow Chemical Company) was heated to 100° C. The temperature was then lowered to 50° C., a drop of dibutyltin dilaurate (DBTDL) and 8.4 g (0.05 mol) of hexamethylene diisocyanate (HDI) was added dropwise. The reaction was stirred for 3 hours until HDI could not be detected by fourier transform infrared detection (FTIR) and high performance liquid chromatography (HPLC) in the reaction mixture. The temperature was raised to 70° C. and a vacuum was applied (1 mmHg) to remove possible HDI residue. 40.1 g of the final product was obtained as a viscous liquid.

### Comparative Example 2 (CE 2)

2.5 g of CE 1 was dissolved in 70 ml of toluene. 9.05 g of hydride terminated poly(dimethylsiloxane) (Mn=580) (available from Aldrich Chemical Company) and 28 mg of SYL-OFF® 4000, a blend of platinum catalyst and vinyl functional silicon polymer available from Dow Corning, in 1 ml of toluene were added at room temperature. The reaction mixture was heated to reflux at 110° C. under nitrogen for 7 hours. After the solvent was removed, the reaction mixture was analyzed by gas phase chromatography (GPC) and hydrogen nuclear magnetic resonance (¹H NMR) spectroscopy. The GPC results showed no molecular weight change compared to the raw materials and ¹H NMR analysis showed the allyl group still existed, indicating no effective reaction.

### Inventive Example 1 (IE 1)

An allyl alcohol polyether of Formula II, wherein the “n” is zero, the “m” is 7 and R is hydrogen and having an overall molecular weight of 350 g/mol, was treated prior to usage by toluene azeotropic distillation. 58.0 grams (g) of the allyl alcohol polyether was added into 100 milliliters (ml) of toluene at 25° C. followed by the addition of 13.5 g of hexylmethylene diisocynate (available from Aldrich Chemical Company). The mixture was heated to reflux and FTIR was used to monitor the reaction conversion. The conversion is a function of the disappearance of the characteristic peak of —NCO at approximately 2200 cm⁻¹. After the isocynate is converted, the reaction mixture was cooled down to room temperature. The solvent was removed by rotary evaporation yielding 75 g of the diallyl carbamate polyether polyol.

### Inventive Example 2 (IE 2)

49 grams (g) of an allyl alcohol polyether (treated prior to usage by toluene azeotropic distillation) of Formula II, wherein A is a propylene oxide group, “n” is 6, “m” is 23 and R is hydrogen and having an overall molecular weight of 1450 g/mol, was diluted with 150 ml of ethyl acetate (EtOAc). 16 g of methylene diphenyl diisocynate (MDI) in 50 ml of EtOAc was added to the allyl alcohol polyether solution gradually under stirring in an ice bath. The temperature was allowed to rise to 25° C. and stirred until the isocynate peak shown in the FTIR spectrum disappeared. The solvent was removed by rotary evaporation yielding 65 g of the diallyl carbamate polyether polyol.

The ¹H NMR spectra contains peaks at 5-6 ppm corresponding to the allylic protons, 7-7.5 ppm corresponding to aromatic protons of the benzene ring in MDI, 3.6 ppm and 1 ppm corresponding to ethoxy and propyloxy groups in the diallyl carbamate polyether polyol.

### Inventive Example 3 (IE 3)

A catalyst solution of 80 mg of SYL-OFF® 4000, a blend of platinum catalyst and vinyl functional silicon polymer available from Dow Corning, in 2 ml of toluene, 17.3 g of dihydrogen terminated polydimethylsiloxane having an average molecular weight of 550 g/mol available from Aldrich Chemical Company, and 27.4 g of the diallyl carbamate polyether polyol from Example 1 were added to 250 ml of toluene at 25° C. under nitrogen. The mixture was stirred and heated to reflux to ensure complete conversion. ¹H NMR was used to monitor conversion by observing the disappearance of the allylic protons at around 5-6 ppm. After the reaction was complete, the reaction mixture was cooled to room temperature and the solvent was removed by rotary evaporation to afford the linear silicone block copolymer as a liquid.

### Inventive Example 4 (IE 4)

IE 4 is identical to IE 3 except that the dihydrogen terminated polydimethylsiloxane has an average molecular weight of 2,000 g/mol.

### Inventive Example 5 (IE 5)

IE 5 is identical to IE 3 except that the dihydrogen terminated polydimethylsiloxane has an average molecular weight of 4,000 g/mol.

### Inventive Example 6 (IE 6)

A catalyst solution of 74 mg of SYL-OFF® 4000, a blend of platinum catalyst and vinyl functional silicon polymer available from Dow Corning, in 2 ml of toluene, 15.5 g of dihydrogen terminated polydimethylsiloxane having an average molecular weight of 222 g/mol available from Aldrich Chemical Company, and 20 g of the diallyl carbamate polyether polyol from Example 2 were added to 250 ml of toluene at 25° C. under nitrogen. The mixture was stirred and heated to reflux to ensure complete conversion. ¹H NMR was used to monitor conversion by observing the disappearance of the allylic protons at around 5-6 ppm. After the reaction was complete, the reaction mixture was cooled to room temperature and the solvent was removed by rotary evaporation to afford the linear silicone block copolymer as a liquid.

### Inventive Example 7 (IE 7)

IE 7 is identical to IE 6 except that the dihydrogen terminated polydimethylsiloxane has an average molecular weight of 4,000 g/mol.

Table 1 reports the polydispersity index values for inventive examples 1-7 compared to the polydispersity index values for Si 2000 and Si 4000 which are dihydrogen terminated polydimethylsiloxanes having an average molecular weight of 2,000 g/mol and 4,000 g/mol, respectively. In Table 1, Mₙ refers to number average molecular weight, M_{w} refers to weight average molecular weight, and PDI refers to polydispersity index which is the ratio M_{w}/Mₙ.

TABLE 1
Polymer Data for Examples 1-6 Compared to Polysiloxanes

| Example | Mₙ | M_{w} | PDI |
|---|---|---|---|
| Si 2000 | 1502 | 3507 | 2.33 |
| Si 4000 | 2047 | 7012 | 3.43 |
| IE 1 | 142 | 293 | 2.05 |
| IE 2 | 698 | 1078 | 1.54 |
| IE 4 | 2847 | 8046 | 2.83 |
| IE 5 | 2840 | 10001 | 3.52 |
| IE 6 | 2281 | 5971 | 2.62 |
| IE 7 | 3669 | 18754 | 5.11 |

The Mn and Mw values in Table 1 were measured using conventional gas phase chromatography (GPC) conditions according to Table 2. The samples were prepared at concentrations of 5 milligrams/milliliters (mg/ml) in mobile phase. All samples appeared completely soluble in toluene and were filtered through a 0.45 micrometer (μm) filter prior to GPC analysis.

TABLE 2
GPC Conditions for PDI Determination

| | |
|---|---|
| Mobile | HPLC grade Toluene |
| Phase | |
| Pump | Agilent 1200 with continuous vacuum degassing |
| Flow Rate | Nominal 0.3 ml/min |
| Injection | 20 μl |
| Columns | Two PLgel Mini MIXD columns (25 cm × 4.6 mm × 5 μm) |
| | connected in series and held at 35° C. |
| Detector | Agilent differential refractive index (DRI) detector at 35 C. |
| | The detector polarity was reversed for sample injections |
| | such that the peaks acquired by the collection software |
| | were positive. |
| Calibration | Narrow MWD polydispersity standards fro Polymer |
| | Laboratories were used for calibration over the |
| | molecular weight range from 0.58 to 316.5 kg/mol |
| | at the concentration of about 0.5 mg/ml in mobile |
| | phase. The calibration was fit to linear. |
| Software | Data was acquired and processed using Agilent |
| | Chemstation (Version B 02.01-SR1) and Agilent GPC- |
| | Addon software (Rev. B 01.01). |

Table 3 presents the compositions for Examples 8-11 and Comparative Examples 1-2 used in the softening testing.

TABLE 3
Compositions of Examples 8-11 and Comparative Examples 1-2

| | | Linear | Surfac- | Surfac- | Surfac- | |
|---|---|---|---|---|---|---|
| | DI | Silicon Block | tant | tant | tant | Surfactant |
| | water | Copolymer | A1 | A2 | B1 | B2 |
| CE 1 | 404.0 g | — | 1.0 g | 1.0 g | — | — |
| IE 8 | 400.0 g | 4.0 g of IE 4 | 1.0 g | 1.0 g | — | — |
| IE 9 | 400.0 g | 4.0 g of IE 5 | 1.0 g | 1.0 g | — | — |
| CE 2 | 404.0 g | — | — | — | 1.0 g | 1.0 g |
| IE 10 | 400.0 g | 4.0 g of IE 6 | — | — | 1.0 g | 1.0 g |
| IE 11 | 400.0 g | 4.0 g of IE 7 | — | — | 1.0 g | 1.0 g |

Surfactant Al is ECOSURF™ EH-3, A2 is ECOSURF™ EH-6, B1 is TERGITOL™ 15-S-3, and B2 is TERGITOL™ 15-S-9, all available from The Dow Chemical Company.

Examples 8-11 and Comparative Examples 1-2 were produced by adding the surfactants and linear silicone block copolymers from Inventive Examples 4-7 into a beaker and stirred to ensure thorough mixing. The water was added very slowly and the mixture was maintained in a uniform state before more water was added. The pH of the mixture was tested by a pH meter. If the pH was outside the range of 5.5 to 6.5, 5.0% acetic acid solution or 5.0% sodium bicarbonate solution was added to adjust the pH to the indicated range.

Fabric (pure polyester or a cotton-polyester blend) is immersed in the silicone emulsion. The liquid/fabric weigh ratio was 13:1. The finishing process included padding the fabrics through a padding machine twice followed by a heat setting of 160° C. The liquid ratio on the fabric was 80% after padding. The heat-setting time for the polyester fabric and the cotton-polyester blend fabric was 60 S and 90 S, respectively.

After finishing, fabrics were touched and evaluated by 11 people. Based on their feedback the performances of the inventive and comparative examples were evaluated. In Table 4, a “—” refers to the hand feel of the comparative examples and “↑” refers to an improved hand feel compared to the comparative examples. As indicated below in Table 4, the inventive examples have improved “feel” than the comparative examples.

TABLE 4
Results for Fabric Feel

Hand feels

| Formulation | Pure Polyester | C/T (T/120) |
|---|---|---|
| Comparative example 1 | — | — |
| Inventive example 4 | ↑ | ↑ |
| Inventive example 5 | ↑ | ↑ |
| Comparative example 2 | — | — |
| Inventive example 6 | ↑ | ↑ |
| Inventive example 7 | ↑ | ↑ |

1. A composition comprising a diallyl carbamate polyether of Formula I 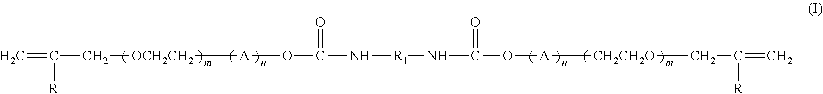
wherein R is a hydrogen or a C₃-C₈ alkyl group, A is a three carbon or four carbon oxylalkylene unit, “m” is an integer from 6 to 50, and “n” is an integer from 0 to 30.

2. A composition comprising a linear silicone block copolymer of Formula IV 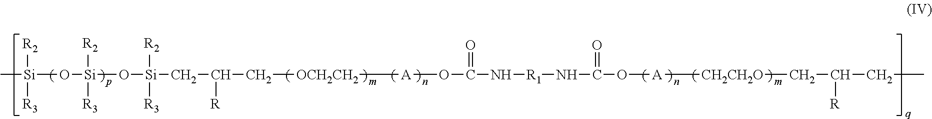
wherein R is a hydrogen or a C₃-C₈ alkyl group, A is a three carbon or four carbon oxylalkylene unit, “m” is an integer from 6 to 50, “n” is an integer from 0 to 30, and the average number for “q” is from 2 to 50.

3. A method of synthesizing a linear silicone block copolymer comprising the steps of:
a) contacting an allyl alcohol polyalkoxylate glycol of Formula II 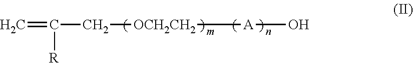
wherein R is a hydrogen or a C₃-C₈ alkyl group, A is a three carbon or four carbon oxylalkylene unit, “m” is an integer from 6 to 50, and “n” is an integer from 0 to 30, with a diisocyanate of Formula III
OCN—R₁—NCO (III)
wherein R₁ is at least one of methylene diphenyl, hexamethylene, toluene, 1,5-napthalene, or isophorone,
yielding a diallyl carbamate polyether of Formula I 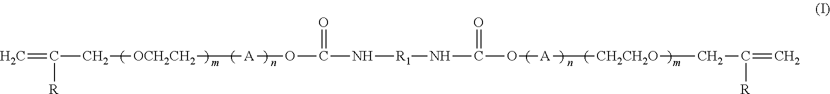
wherein R is a hydrogen or a C₃-C₈ alkyl group, A is a three carbon or four carbon oxylalkylene unit, “m” is an integer from 6 to 50, and “n” is an integer from 0 to 30; and
b) contacting the diallyl carbamate polyether with a polysiloxane to yield a linear silicone block copolymer of Formula IV 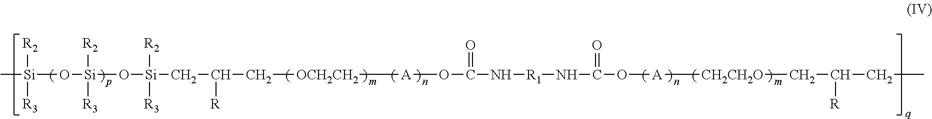
wherein R is a hydrogen or a C₃-C₈ alkyl group, A is a three carbon or four carbon oxylalkylene unit, “m” is an integer from 6 to 50, and “n” is an integer from 0 to 30.

4. The method of claim 3, wherein step a) is performed without the presence of a catalyst.
